(19) United States
(12) Patent Application Publication
(10) Pub. No.: US 2021/0046666 A1
(43) Pub. Date: Feb. 18, 2021

(54) PROCESSING MODULE FOR A BUILDING PANEL

(71) Applicant: United Grinding Group Management AG, Bern (CH)

(72) Inventors: Michael CLOOTS, St. Gallen (CH); Pascal BRUNNER, Hosenruck (CH); Alex FRAUCHIGER, St. Gallen (CH); Kai GUTKNECHT, Uznach (CH); Christoph PLÜSS, Burgdorf (CH); Hanspeter SAUTTER, Otelfingen (CH); Patrik HOCHREUTENER, Winterthur (CH); Vincent MAAG, Zurich (CH)

(21) Appl. No.: 16/992,426

(22) Filed: Aug. 13, 2020

(30) Foreign Application Priority Data
Aug. 16, 2019 (EP) 19192062.8

(51) Int. Cl. B26D 1/48; E04C 2/00; B26D 7/06; B26D 5/00; B26D 7/02

(52) U.S. Cl. CPC B26D 1/48; E04C 2/00; B26D 7/025; B26D 5/00; B26D 7/06

(57) ABSTRACT

The present invention relates to a processing module for a building panel and a method for processing a building panel. The processing module for a building panel comprises an input station and a manoeuvring station. The input station comprises a reception for a building panel and the building panel bundles several individual building elements. The manoeuvring station comprises a swiveling device for transporting and swiveling the building panel.

### TECHNICAL FIELD

The present invention relates to a processing module for a building panel and a method for processing a building panel. The building panel may have a plate-shaped basic structure from which individual building elements protrude in the form of pins or fingers. The individual construction elements can be separated from the plate-shaped basic structure after processing in the processing module. The individual, separated components can be understood as products to be manufactured.

### BACKGROUND OF THE INVENTION

Conventional processing modules for building panels are large, highly complex and complicated devices that nevertheless only have a limited functional range. The conventional processing modules for building panels can therefore be improved even further.

It is desirable to provide a simpler processing module. It is also desirable to provide a processing module that combines more different functions.

### SUMMARY OF THE INVENTION

It is an object of the present invention to provide an improved processing module for a building panel/board, which is more effectively constructed.

This object is solved by a processing module for a building panel and a method for processing a building panel according to the independent claims. Advantageous embodiments and further improvements can be found in the dependent claims and in the following description.

The present invention comprises a processing module for a building panel with an input station and a manoeuvring station. The input station comprises a receptacle for a building panel and the building panel bundles several individual building elements. The manoeuvring station comprises a swivel device for transporting and swiveling the building panel.

The processing module for a building panel according to the present invention is very elegant and simply constructed. At the same time, it can combine more different functions and/or fulfil the different functions more precisely than a conventional processing module. As a result, the processing module according to the invention is more effectively constructed compared to the prior art.

The building panel can have a panel-shaped basic structure from which the individual building elements protrude in a pin or finger shape. The building panel or the panel-shaped basic structure can be understood as a carrier structure or support structure for the building elements. The individual building elements can be separated from the plate-shaped basic structure after processing in the processing module. The individual, separated building elements can be understood as the actual product to be manufactured. The building panel can be produced by an additive manufacturing process such as 3D printing.

The processing module can therefore be understood as a component separation module. Furthermore, the processing module can also be a combined component separation and building panel reprocessing module. The processing module then comprises not only the input station and the manoeuvring station, but also a building panel reprocessing station. The building panel reprocessing station can allow mechanical processing of the building panel after separation of the individual components and can include a milling head, a grinding head and/or similar. After the individual components have been separated from the basic plate-like structure of the building panel, the building panel can be moved relative to the building panel reprocessing station and mechanically processed there.

This may involve restoring a desired surface finish (such as flatness or roughness) to the building panel and/or removing any remnants or stumps of the building elements.

In one embodiment, the processing module also includes a granulate bath that can be pressurized with compressed gas to hold and fix the individual components relative to the building panel. The granulate bath is in a quasi-solid state when at rest and in a quasi-liquid state when exposed to compressed gas (for example compressed air or an inert gas under pressure or similar).

The granulate bath can be located in a component collection container. The component collection container can be raised relative to the building panel with the individual components by means of the swivel device so that the individual components on the building panel are immersed in the granulate bath, whereby the granulate bath is exposed to compressed gas and is therefore in a quasi-liquid state. The granulate bath, which can be perceived as solid in the rest state, is flushed with compressed gas during the immersion of the components so that it assumes a state which can be perceived as liquid and in which the components can be immersed without major frictional losses. Subsequently, the individual components arranged on the building panel are immersed in the component collection container or the quasi liquid granulate.

The compressed gas can be switched off when the components are at least partially or preferably completely immersed in the granulate or when the component collection container has reached its final position. Without the compressed gas purging, the pellets solidify to such an extent that the components are sufficiently fixed in the pellets so that, for example, they are not displaced or entrained by the resulting process forces or shear forces in a subsequent separation process.

The individual construction elements can be separated from the building panel using a sawing device. In one embodiment, the processing module therefore includes a sawing device with a cutting wire for separating the individual components from the building panel. The cutting wire can be a hard material wire, for example of diamond, boron nitride, CBN (cubic crystalline boron nitride) or similar. In one embodiment, the sawing device is a wire saw with a hard material wire, for example a diamond wire saw or a boron nitride or CBN saw. The sawing device or the cutting wire of the sawing device can be guided parallel to the surface of the building panel.

The sawing device works by winding and unwinding the cutting wire. In one embodiment, the sawing device therefore comprises a drive spool and a counter spool, the drive spool being designed to wind the cutting wire in a first direction and the counter spool being designed to tension the cutting wire in an opposite, second direction. In other words, the cutting wire can be wound on the driving spool in the first moving direction (for example, counterclockwise) with a first torque. The winding axis of the drive spool determines the angular velocity or spool speed of the drive spool. The counter spool, which is designed to unwind the cutting wire in the second, opposite direction of movement (for example clockwise), can produce a defined counter torque or second torque at a further angular speed or spool speed of the counter spool. The cutting speed of the cutting wire can be measured and, if desired, kept constant by speed control with feedback signal of the wire speed at a deflection pulley equipped with a speed sensor. The cutting speed is freely adjustable, even during a cutting operation.

The counter-torque of the counter spool can be permanently controlled to ensure a constant wire tension of the cutting wire. The counter-torque of the counter spool necessary for constant wire tension in the cutting wire can be calculated from the current total spool diameter of the unwinding counter spool. Total spool diameter of the unwinding counter spool can be understood as the sum of the spool diameter of the counter spool and the diameter of the currently wound cutting wire. This current total spool diameter of the counter spool can be calculated from the current wire speed and the current spool speed of the counter spool. The actual wire speed or cutting speed of the cutting wire can be determined by a speed sensor or encoder in one of the spools or a deflection pulley. The actual spool speed of the counter spool can be determined by a speed sensor or encoder in the counter spool.

In one embodiment, therefore, the processing module includes a speed sensor to detect an instantaneous cutting speed of the cutting wire, the speed sensor being located, for example, on a deflection roller of the sawing device.

In an embodiment, the processing module further comprises a speed sensor for detecting an instantaneous spool speed of the counter spool.

In an embodiment, the processing module further comprises a control unit designed to control at least one of the spools for a constant wire tension of the cutting wire during a cutting operation. The control unit can calculate the instantaneous total spool diameter of the counter spool together with the instantaneous wound cutting wire from the instantaneous cutting speed of the cutting wire and the instantaneous spool speed of the counter spool. From the current total spool diameter of the counter spool, the control unit can continuously calculate a desired drive torque of the counter spool for a constant wire tension of the cutting wire during a cutting process. In other words, the control unit uses the calculated counter spool drive torque to control a constant wire tension of the cutting wire during a cutting operation. The control unit can also use the calculated drive torque of the counter spool to control a constant cutting speed of the cutting wire during a cutting operation.

At least one of the spools is designed in a version to maintain a defined constant wire tension of the cutting wire even when the sawing device is at rest. The control unit can control at least the counter spool in such a way that the wire tension of the cutting wire remains constant permanently and thus also in the resting state of the sawing device. With the help of a permanently applied wire tension, it is easier to set up the sawing device, for example after a wire break.

In one embodiment, the drive spool and the counter spool are designed to cyclically change their tasks or to change the cutting direction, so that the cutting wire is wound alternately in the first direction and the second direction for cutting. A change of the cutting direction means that the spool that was previously winding unwinds and the spool that was previously unwinding winds up. The control unit can control at least one of the spools in such a way that the wire tension of the cutting wire remains permanent and thus constant even when the cutting direction is changed.

The drive spool and the counter spool can each be arranged in a separate sawing unit. The two sawing units can be linearly movable independently of each other. With the aid of inductive sensors, for example, the displacement of the sawing units can be controlled so that different cutting angles are possible.

The cutting wire can be several kilometers long. During the sawing process, however, the cutting wire cannot be wound up and unwound in its full length, but only a certain section of wire, which can only be a few 100 m long. Preferably, only between 1 and 10% of the total length of the cutting wire is used for a current cutting operation, further preferably between 1 and 5% of the total length of the cutting wire.

In order to wind and unwind the cutting wire as orderly and wear-free as possible, the drive spool and the counter spool can be moved up and down against each other. In one embodiment, the processing module therefore includes a pendulum device for the drive spool and/or the counter spool. The pendulum device is designed to move the drive spool and/or the counter spool up and down substantially perpendicular to a cutting direction of the cutting wire. In one embodiment, the pendulum device is designed to control the movement of the drive spool and/or the counter spool in response to an instantaneous cutting speed of the cutting wire. In one embodiment, the pendulum device is designed to move the drive spool and/or the counter spool independently of each other so that different cutting angles can be set.

In an embodiment, the processing module further includes a wear monitoring device designed to measure a cutting force of the cutting wire during a cutting operation and to output a statement about an actual wear of the cutting wire based on the measured cutting force. An increasing cutting force can be used to derive an increasing wire wear. From a certain wire wear, a previously unused wire section can be used. This can be repeated until all wire sections are engaged. The cutting wire is thus subject to sectional wear.

In an embodiment, the processing module also includes a wire breakage monitoring device designed to measure a spool speed of the drive spool and/or a spool rotation time of the counter spool and to output a statement about a possible wire breakage on the basis of the measured spool speed. In this way, the speeds of preferably both spools are observed during cutting or sawing, whereby a possible wire break can be detected immediately.

After separating the components from the building panel, the building panel can be reprocessed. For this purpose, a panel reprocessing station or panel reprocessing device can be moved relative to the panel. Preferably the panel reprocessing station is mounted upside down and moves under the panel. Reconditioning is a mechanical processing of the building panel by, for example, milling, grinding, polishing and the like. Mechanical processing or reworking of the building panel can be carried out until a desired surface quality and/or plane parallelism of the building panel is achieved.

The present invention further comprises a method for processing a building/construction panel. The method comprises the following steps:
Providing a processing module comprising an input station and a maneuvering station,
Inserting a building panel into a receptacle of the input station, whereby the building panel bundles several individual building elements, and
Transporting and/or swiveling the building panel with the aid of a swivel device in the manoeuvring station.

In detail, the method for processing a building panel may include one or more of the following steps:
Inserting a building panel into a construction container.

The building panel may have a plate-shaped base structure from which the individual building elements protrude in a pin or finger shape. The building panel may be produced by 3D printing and, if necessary, cleaned of powder residues. The construction tank may have a box-like shape which is at least partially open at the top and, if necessary, also at the bottom. The construction tank may be frame-shaped.
Positioning of the construction container in a receptacle in the entry station using a mobile transport aid.

The receptacle can be a (first) linearly moveable table. The receptacle or table can, for example, be moved linearly by means of a mandrel with a building panel clamping system. The transport aid can be moved manually or automatically.
Moving the table with the construction container from the entry station to the manoeuvring station using the mandrel and the clamping system.
Gripping and lifting of the construction container from the table by means of a swivel device.

The swivel device can be understood as a handling unit with a swivel mechanism. Lifting the construction container from the table is sufficient if there is no contact between the construction container and the table.
Moving the table (without the construction container) from the manoeuvring station back to the entry station.

The mandrel with clamping system is now exposed so that the swivel device can place the construction container over the mandrel with clamping system.
Lowering the construction container onto the mandrel and the clamping system using the swivel device.

If the construction container is at least partially open at the bottom, the mandrel inside the construction container can be approached directly to the underside of the building panel. An additional, optional base plate can also be provided between the mandrel and the underside of the panel-shaped base structure of the building panel.
If necessary, attach the building panel with the aid of the base plate to the mandrel and the clamping system through the at least partial opening in the base of the construction container.

The tensioning system is arranged on the mandrel in such a way that the building panel or, where appropriate, the base plate can be easily connected to the mandrel.
Lowering of the construction container relative to the building panel and/or lifting of the building panel relative to the construction container by means of the swivel device.

Since the mandrel with clamping system is firmly connected to the building panel either directly or by means of the base plate, the building panel is moved to a raised position by the mandrel inside the construction container during the relative movement between building panel and construction container.

In the raised position, the building panel protrudes (preferably completely) from the construction container together with the individual building elements.
Release the swivel device from the construction container.

The construction hopper can now be in the lowest possible position. The swivel device can now be moved to the height of the exposed building panel.
Detach the building panel from the base plate.

To release the building panel from the optional base plate, the mandrel with clamping system can include a release mechanism. The building panel can now be lifted from the base plate.
Grip the building panel using the swivel device.

After the swivel device has been moved to the height of the exposed building panel, it can grip the building panel sideways, for example.
Further lifting of the building panel using the swivel device.

The building panel can be lifted until the linearly movable table can be moved under the building panel.
Moving the table from the entry station back to the manoeuvring station and under the building panel using the mandrel and clamping system.

The table is now used to cover the mandrel and the clamping system to protect against dust or powder residues.
Swivel the building panel using the swivel device so that the building panel faces an adapter plate and the individual components face away from the adapter plate.

The building panel is lifted so that it can be swiveled or rotated above the table. The swiveling can be a swiveling through 180°. As noted above, the table now protects the mandrel and the clamping system from contamination by falling powder residues from the building panel with the individual components. The swiveling device moves the building panel under the adapter plate.
Fasten the building panel to the adapter plate using a fixing system.

The fastening can be sufficiently strong to allow the individual components to be separated from the building panel in the following and, if necessary, to allow the building panel to be reprocessed.
Detaching the swivel device from the building panel.
Moving a tray with a component collecting container under the building panel, wherein the component collecting container comprises a granulate bath.

The deposit can be the first linearly movable table described above or an additional second linearly movable table. The deposit or the linearly movable table secures the individual components during and after a separation process from the building panel. For this purpose, the tray with the component collection container arranged on it moves under the building panel, which is attached to the adapter plate.
Gripping and lifting the component collecting container by means of the swivel device so that the individual components on the building panel are immersed in the granulate bath, whereby the granulate bath is pressurized with compressed gas and is in a quasi-liquid state.

The swiveling device grips the component collecting container and lifts it. Subsequently, the individual components arranged on the building panel are immersed in the component collecting container, which is filled with the granulate. In a final position the components are preferably completely immersed in the granulate. To ensure that the components are immersed in the granulate bath without major frictional losses, the granulate bath is flushed with compressed gas (e.g. compressed air) during immersion (preferably from below). As a result, the pellet bath assumes a state that can be perceived as liquid. During this state, the individual components arranged on the building panel can be immersed in the granulate bath without much resistance.
The pressurized gas rinsing of the granulate bath is stopped so that the granulate bath is in a quasi-solid state and the individual components are fixed to the building panel.

The compressed gas can be switched off when the components are at least partially or preferably completely immersed in the pellets or when the component collecting container has reached its final position. Without the pressurized gas purging, the granulate solidifies to such an extent that the components are sufficiently fixed in the granulate so that they are not displaced or entrained by the resulting process forces or shear forces in a subsequent separation process, for example.
Separation of the individual components from the building panel using a sawing device.

The sawing device is preferably a wire saw and more preferably a diamond wire saw. The sawing device or the wire of the sawing device can be guided parallel to the surface of the building panel. The sawing device or the wire of the sawing device can be guided through the material with an oscillating movement.

The sawing device or the wire of the sawing device or the cut-off cut is preferably made as close as possible to a junction between the component and the building panel, in other words at the transition between the building panel and the individual components. This has the advantage that after the components have been cut off, only minimal component residues remain or protrude from the building panel or building panel residues from the components. The sawing device or the wire of the sawing device or the cutting cut can also be guided at a defined distance from the building panel.
Lowering of the component collecting container by means of the swivel device.

The component collecting container contains the individual components that have just been cut off. The component collecting container is lowered so far that it can be set down on the already waiting tray or the (second) linearly movable table.
Setting down the component catcher on the tray.
Moving the tray with the component collecting container from the manoeuvring station to a starting station.

The tray or the second linearly movable table moves with the component collecting container to its original position outside the processing module. In this position, the component collecting container with the individual components can be transported to a subsequent process, for example with the aid of a transport aid.
Output of the component collecting container with the individual components from the output station using the mobile transport means.

After the components have been separated and the components have been discharged from the processing module, the building panel attached to the adapter plate can be reprocessed.
Moving a building panel reprocessing station relative to the building panel attached to the adapter plate.

For the reprocessing of the building panel, a building panel reprocessing station mounted upside down preferably moves under the building panel.
Mechanical processing of the building panel with the aid of the building panel reprocessing station.

Mechanical processing or reworking of the building panel can be carried out until a desired surface quality and/or plane parallelism of the building panel is achieved. The mechanical processing or finishing can be milling, grinding, polishing or similar.
Gripping the building panel with the swivel device.

When the building panel reprocessing is complete, the tipping device grips the building panel.
Detaching the building panel from the adapter plate.

This releases the clamping system that held the now reconditioned building panel to the adapter plate.
Swinging and/or transporting the building panel back into the building container by means of the swivel device.

The remanufactured building panel, now without the individual components, is moved back to the waiting building container by the swivel device. The building panel can preferably be turned by 180° again by the swivel device so that it can be set down on the waiting building container in its original position.
Release the swivel device from the building panel.

After placing the building panel on the building container and fastening the building panel to the base plate of the building container if necessary, the swivel device can be detached from the building panel.
Grip the building container with the swivel device.

The tray or the second linearly movable table releases the building container again. The swivel device grips the building container with the fixed building panel and lifts the building container so far that the first linearly movable table can be moved under the building container so that the swivel device can set the building container down on the first linearly movable table.
Position the building container on the first linearly movable table using the swivel device.

After the building container is placed on the first linearly movable table, the table with the building container and the remanufactured building panel can be moved to its original position outside the processing module.
Moving the table with the building container and building panel from the manoeuvring station back to the entry station.

From here the building container can be picked up by a building container transport vehicle.

Further features, advantages and possible applications of the present invention result from the following description, the embodiments and the figures. All described and/or illustrated features can be combined with each other in individual claims, figures, sentences or paragraphs regardless of their representation. In the figures, the same reference signs stand for identical or similar objects.

### BRIEF DESCRIPTION OF THE FIGURES

FIG. 1 shows a processing module for a building panel according to an embodiment of the invention.

FIG. 2 shows a detailed view of a sawing device for cutting individual components from the building panel.

FIG. 3 shows a top view of the sawing device for cutting individual components from the building panel.

### DETAILED DESCRIPTION OF THE EMBODIMENTS

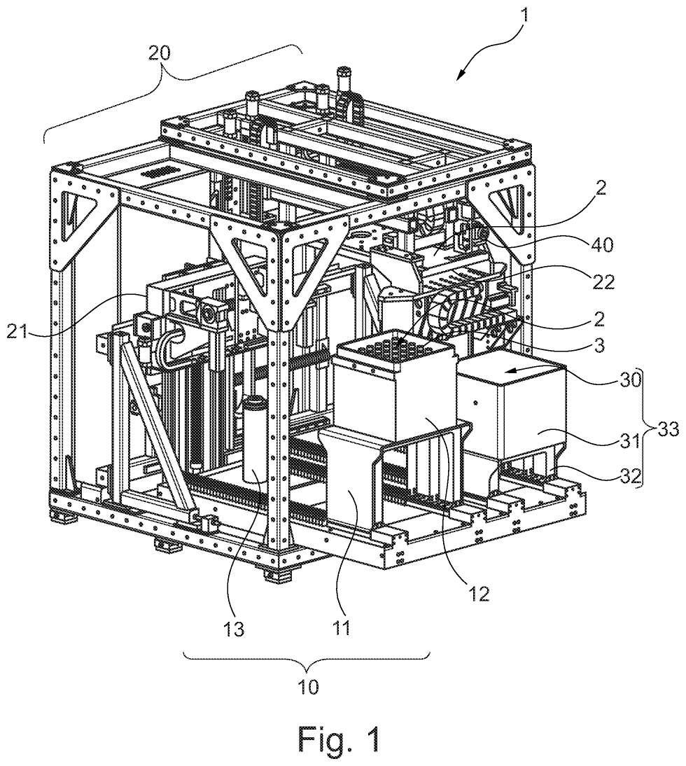

FIG. 1 shows a processing module 1 for a building panel 2 with an input station 10 and a manoeuvring station 20. The input station 10 comprises a reception 11 for a building panel 2. The manoeuvring station 20 comprises a swiveling device 21 for transporting and swiveling the building panel 2.

The building panel 2 bundles several individual components 3. The building panel 2 can have a plate-shaped basic structure from which the individual components 3 protrude in the form of pins or fingers. The individual components 3, which are later separated, can be understood as the actual products to be manufactured.

The processing module 1 comprises a granulate bath 30, which can be pressurized with compressed gas, for reception and fixing of the individual components 3 relative to the building panel 2. The granulate bath 30 is in a quasi-solid state when at rest and in a quasi-liquid state when pressurized gas is applied. The granulate bath 30 is located in a component collecting container 31. The component collecting container is lifted relative to building panel 2 with the individual components 3 by means of the swiveling device 21 so that the individual components 3 are immersed in the granulate bath 30 at building panel 2. The granulate bath 30, which can be perceived as solid, is flushed with compressed gas during the immersion of the components 3 so that it assumes a state which can be perceived as liquid and in which the components 3 can be immersed without major frictional losses. Subsequently, the individual components 3 arranged on the building panel 2 are immersed in the component collection container 31 or the quasi liquid granulate. The compressed gas is switched off when the components 3 are at least partially or preferably completely immersed in the granulate. Without the compressed gas purging, the granulate solidifies to such an extent that the components 3 are sufficiently fixed in the granulate so that they are not displaced or entrained by the shear forces in a subsequent separation process. The granulate bath 30 is described in more detail below.

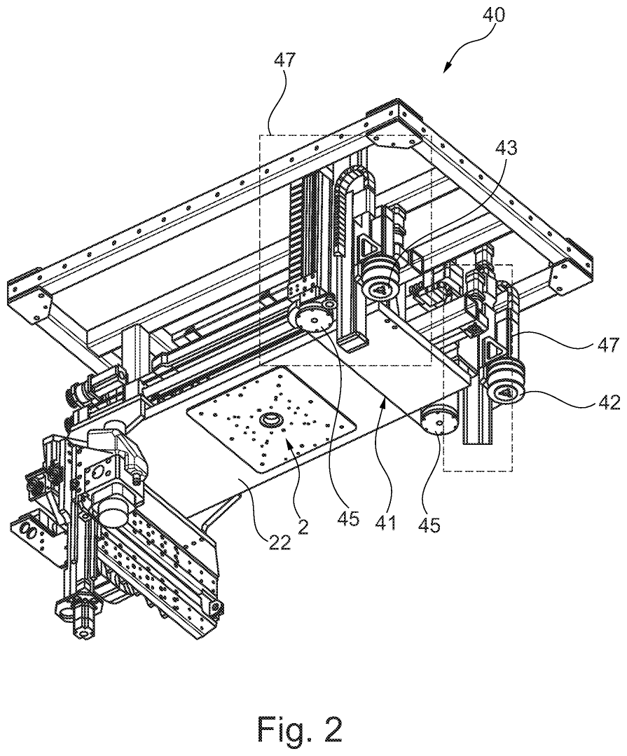

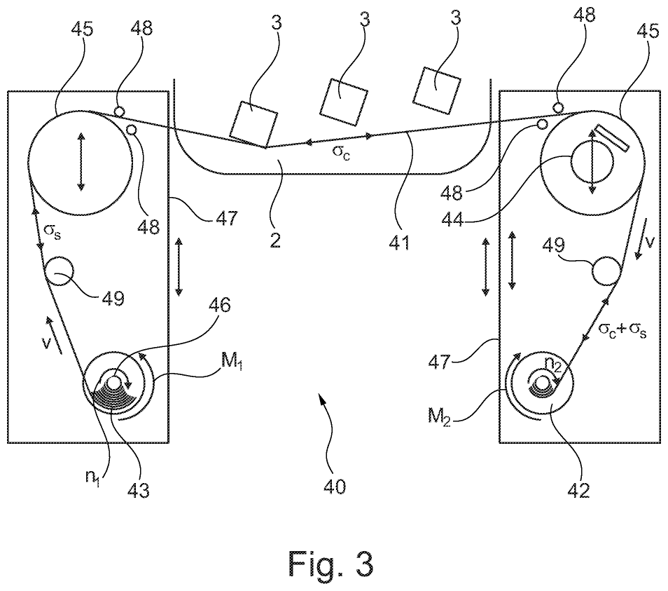

The individual components 3 are then separated from the building panel 2 using a sawing device 40. The processing module 1 therefore also includes the sawing device 40 with a cutting wire 41 for separating the individual components 3 from the building panel 2. The sawing device 40 is a diamond wire saw in which the cutting wire 41 is guided parallel to the surface of the building panel 2. The sawing device 40 on is explained in more detail below with reference to FIGS. 2 and 3.

After the components 3 have been separated from building panel 2, the building panel 2 is reprocessed by moving an overhead building panel reprocessing station relative to building panel 2. The reprocessing is a mechanical processing of building panel 2 by, for example, milling, grinding, polishing and similar. The panel reprocessing station is described in more detail below.

The process in the processing module 1 can be as follows:
Inserting a building panel 2 into a building container 12.
Positioning the building container 12 on a reception 11 or a table 11 in the input station 10 using a mobile transport aid.
Moving the table 11 with building container 12 from the input station 10 to the manoeuvring station 20 by means of a mandrel 13 with a building panel clamping system.
Gripping and lifting the building container 12 from the table 11 by means of a swiveling device 21.
Moving the table 11 (without the building container) from the manoeuvring station 20 back to the input station 10. The mandrel 13 with a clamping system is now exposed.
Lowering the building container 12 onto the mandrel 13 and the clamping system using the swiveling device 21. The mandrel 13 can be approached inside the building container 12 right up to the underside of the building panel 2. An optional base plate can be placed between the mandrel and the underside of the panel-shaped base structure of building panel 2.
Fix the building panel 2 or the optional base plate, if necessary using a clamping system, to the mandrel 13 and the clamping system through an opening in the bottom of building container 12.
Lowering of building container 12 relative to building panel 2 and/or raising of building panel 2 relative to building container 12 by means of the swiveling device 21. During the relative movement between building panel 2 and building container 12, building panel 2 is moved to a raised position inside building container 12 by the mandrel 13.
Release the swiveling device 21 from the building container 12.
If necessary, release building panel 2 from the optional base plate.
Grip the building panel 2 using the swiveling device 21.
Lifting the building panel 2 using the swiveling device 21.
Moving the table 11 from the input station 10 back to the manoeuvring station 20 and under the building panel 2 using the mandrel 13 and the clamping system. Table 11 is used to cover the mandrel 13 and the clamping system to protect against dust or powder residues.
Swivel the building panel 2 using the swiveling device 21 so that the building panel 2 faces an adapter plate 22 and the individual components 3 face away from the adapter plate 22. The building panel 2 is lifted so far that it can be swiveled or rotated above the table 11. The swiveling can be a swiveling by 180°. The swiveling device 21 moves the building panel 2 under the adapter plate 22.
Fasten the building panel 2 to the adapter plate 22 using a fixing system. The fixing is sufficiently strong to allow the individual components 3 to be separated from building panel 2 in the following and to allow building panel recycling.
Detaching the swiveling device 21 from the building panel 2.
Moving a tray 32 with a component collecting container 31 under the building panel 2, wherein the component collecting container 31 comprises a granulate bath 30. The tray 32 is a second linearly movable table 32.
Gripping and lifting the component collecting container 31 by means of the swiveling device 21 so that the individual components 3 on the building panel 2 are immersed in the granulate bath 30, the granulate bath 30 being acted upon by compressed gas and being in a quasi-liquid state.
stopping the pressurized gas flushing of the granulate bath 30 so that the granulate bath 30 comes into a quasi-solid state and the individual components 3 are fixed in the granulate bath 30 so as not to be displaced by shear forces in a subsequent separation process.
Separation of the individual components 3 from the building panel 2 using a sawing device 40, which is explained in more detail below with reference to FIGS. 2 and 3.
Lowering of the component collection container 31 using the swiveling device 21. The component collection container 31 contains the individual components 3 that have just been separated.
Lowering the component collecting container 31 onto the tray 32 (second linearly movable table).
Moving the tray 32 with the component collecting container 31 from the maneuvering station 20 to a starting station 33.
Output of the component collection container 32 with the individual components 3 from the output station 33 using the mobile transport means.
Moving a building panel recycling station mounted upside down relative to and here under the building panel 2 attached to the adapter plate 22.
Mechanical processing (milling, grinding, polishing or similar) of building panel 2 with the aid of the building panel reprocessing station.
Gripping the building panel 2 using the swiveling device 21.
Detaching the building panel 2 from the adapter plate 22.
Swivel (here 180°) and transport the building panel 2 back into the building container 12 using the swiveling device 21.
Detach the swiveling device 21 from the building panel 2.
Gripping the building container 12 by means of the swiveling device 21. The swiveling device 21 grips the building container 12 with the fixed building panel 2 and lifts the building container 12 so far that the first linearly movable table 11 can be moved under the building container 12.
Positioning of the building container 12 on the first linearly movable table 11 by means of the swiveling device 21.
Moving the table 11 with the building container and building panel 2 from the manoeuvring station 20 back to the input station 10.

FIGS. 2 and 3 show detailed views of the sawing device 40 for cutting the individual components 3 from the building panel 2. The sawing device 40 here is a diamond wire saw, the cutting wire 41 here is a hard coated wire.

The sawing device 40 comprises a drive spool 42 and a counter spool 43. The drive spool 42 is designed to wind the cutting wire 41 in a first direction. The counter spool 43 is designed to tension the cutting wire 41 in an opposite, second direction.

The sawing device 40 works by winding and unwinding the cutting wire 41. The cutting wire 41 can be several kilometers long. During the sawing process, however, the cutting wire 41 is not wound up and unwound in its full length, but only a certain section of wire, which can only be a few hundred meters long. Preferably only between 1 and 10% of the total length of the cutting wire 41 is used for a current cutting operation, further preferably between 1 and 5% of the total length of the cutting wire 41.

The cutting wire 41 is wound onto the drive spool 42 in the first direction of movement (here clockwise) with a torque M₂. The winding axis of the drive spool 42 determines the angular velocity or spool speed n₂. The counter spool 43, which is designed to unwind the cutting wire 41 in the second, opposite direction of movement (here counter-clockwise), produces a defined counter-torque M₁ at an angular speed or spool speed n₁. The cutting speed v of the cutting wire 41 can be measured by a speed control with feedback signal of the wire speed at a deflection roller 45 provided with a speed sensor 44 and, if desired, kept constant. The cutting speed is freely adjustable, even during a cutting operation.

The counter-torque M₁ of the counter spool 43 is permanently controlled to ensure a constant wire tension σ_{S} in the cutting wire 41. The counter torque M₁ of the counter spool 43 necessary for the constant wire tension σ_{S} in the cutting wire 41 can be calculated from the current total spool diameter of the unwinding counter spool 43 together with the currently wound cutting wire 41. The current total spool diameter of the counter spool 43 together with the currently wound cutting wire 41 can be calculated from the current wire speed and the current spool speed n₁ of the counter spool 43. The current wire speed or cutting speed v of the cutting wire 41 can be determined by a speed sensor 44 or encoder in a deflection pulley 45; 49. The actual spool speed n₁ of the counter spool 43 can be determined by a speed sensor 46 or encoder in the counter spool 43. σ_{C} is the resulting tension from the cutting force.

Processing module 1 comprises a control unit (not shown) which calculates the instantaneous total spool diameter of the counter spool 43 together with the instantaneous wound cutting wire 41 from the instantaneous cutting speed of the cutting wire 41 and the instantaneous spool speed n₁ of the counter spool 43. Furthermore, the control unit continuously calculates a desired drive torque of the counter spool 43 for a constant wire tension of the cutting wire 41 during a cutting process from the current total spool diameter of the drive spool 42. In other words, the control unit uses the calculated driving torque of the counter spool 43 to control a constant wire tension of the cutting wire 41 during a cutting operation. The control unit can also use the calculated driving torque of the counter spool 43 to control a constant cutting speed v of the cutting wire 41 during a cutting operation.

The control unit can further control at least the counter spool 43 in such a way that the wire tension σ_{S} of the cutting wire 41 remains constant permanently and thus also in the stationary state of the sawing device 40 and/or when changing the cutting direction. A change of the cutting direction means that the spool that was previously winding unwinds and the spool that was previously unwinding winds up. The drive spool 42 and the counter spool 43 are designed to change their tasks so that the cutting wire 41 can be wound alternately in the first direction and the second direction for cutting.

In order to wind and unwind the cutting wire 41 as orderly and wear-free as possible, the drive spool 42 and the counter spool 43 can be moved up and down against each other. For this purpose, processing module 1 comprises a pendulum device for the drive spool 42 and the counter spool 43, which is designed to move the drive spool 42 and the counter spool 43 up and down perpendicular to the cutting direction of the cutting wire 41. The pendulum device can control the pendulum movement of the drive spool 42 and the counter spool 43 in dependence on an instantaneous cutting speed v of the cutting wire 41. The pendulum device can also move the drive spool 42 and the counter spool 43 independently of each other, so that different cutting angles are possible.

Processing module 1 also includes a wear monitoring device that measures a cutting force of the cutting wire 41 during a cutting process and can output a statement on the current wear of the cutting wire 41 based on the measured cutting force. An increasing cutting force can be used to derive an increasing wire wear. From a certain wire wear, a previously unused wire section can be used. This can be repeated until all wire sections are engaged. The cutting wire 41 is thus subject to sectional wear.

Processing module 1 also includes a wire breakage monitoring device which measures a spool speed of the drive spool 42 and/or a spool rotation time of the counter spool 43 and can give an indication of a possible wire breakage on the basis of the measured spool speed. In this way, the speeds of preferably both spools are observed during cutting or sawing, whereby a possible wire break can be detected immediately.

The drive spool 42 and the counter spool 43 can each be arranged in a separate sawing unit 47. The two sawing units 47 can be linearly displaced independently of each other. With the aid of inductive sensors 48, for example, the displacement of the sawing units can be controlled so that different cutting angles are possible. In addition, the sensors 48 help to avoid too large or critical cutting angles. Furthermore, the sensors 48 can be used to detect whether or not the component has been cut.

In addition, it should be noted that “comprising” and “having” does not exclude other elements or steps. It should also be noted that features or steps described with reference to one of the above embodiments may also be used in combination with other features or steps of other embodiments described above. Reference signs in the claims are not to be considered as a restriction.

1. A processing module for a building panel, comprising:
an input station, and
a manoeuvring station,
wherein the input station comprises a reception for a building panel, wherein the building panel bundles a plurality of individual building elements, and
wherein the manoeuvring station comprises a swiveling device for transporting and swiveling the building panel.

2. The processing module of claim 1, further comprising a sawing device with a cutting wire for separating the individual components from the building panel.

3. The processing module of claim 2, wherein the sawing device comprises a drive coil and a counter coil,
wherein the drive spool is adapted to wind the cutting wire in a first direction, and
wherein the counter spool is configured for tensioning the cutting wire in an opposite, second direction.

4. The processing module of claim 2, wherein the drive spool and the counter spool are configured to cyclically change their tasks so that the cutting wire is wound alternately in the first direction and the second direction for cutting.

5. The processing module of claim 2, wherein only between 1 and 10%, preferably between 1 and 5% of a total length of the cutting wire is used for a current cutting operation.

6. The processing module of claim 3, further comprising a control unit adapted to control at least one of the spools for a constant wire tension of the cutting wire during a cutting operation.

7. The processing module of claim 3, further comprising a speed sensor for detecting an instantaneous cutting speed of the cutting wire, wherein the speed sensor is preferably arranged on a deflection roller of the sawing device.

8. The processing module of claim 3, further comprising a speed sensor for detecting an instantaneous spool speed of the counter spool.

9. The processing module of claim 6, wherein the control unit is configured to calculate an instantaneous total spool diameter of the counter spool together with the instantaneous spool rotational speed of the counter spool from the instantaneous cutting speed of the cutting wire and the instantaneous spool rotational speed of the counter spool.

10. The processing module of claim 6, wherein the control unit is further configured to continuously calculate from the instantaneous total spool diameter of the counter spool a desired driving torque of the counter spool for a constant wire tension and/or a constant cutting speed of the cutting wire during a cutting operation.

11. The processing module of claim 3, wherein at least one of the spools is configured to maintain a defined wire tension of the cutting wire also in a rest state of the sawing device.

12. The processing module of claim 2, wherein the sawing device is a wire saw with a hard material wire.

13. The processing module of claim 3, further comprising a pendulum device for the drive spool and/or the counter spool, which is configured to move the drive spool and/or the counter spool up and down substantially perpendicular to a cutting direction of the cutting wire.

14. The processing module of claim 13, wherein the pendulum device is configured to control the movement of the drive spool and/or the counter spool depending on an instantaneous cutting speed of the cutting wire.

15. The processing module of claim 13, wherein the pendulum device is configured to move the drive spool and/or the counter spool independently of each other so that different cutting angles can be set.

16. The processing module of claim 2, further comprising a wear monitoring device, which is configured to measure a cutting force of the cutting wire during a cutting operation and to output an indication of an actual wear of the cutting wire on the basis of the measured cutting force.

17. The processing module of claim 3, further comprising a wire breakage monitoring device which is configured to measure a spool speed of the drive spool and/or a spool rotation time of the counter spool and to output a statement on a possible wire breakage on the basis of the measured spool speed.

18. The processing module of claim 1, further comprising a granular bath which can be acted upon by compressed gas for receiving and fixing the individual components relative to the building panel, wherein the granular bath is in a quasi-solid state in a rest state and is in a quasi-liquid state when acted upon by compressed gas.

19. A method for processing a building panel, comprising:
providing a processing module and a manoeuvring station,
inserting a building panel into a reception of the input station, the building panel bundling a plurality of individual building elements, and
transporting and/or swiveling the building panel by means of a swiveling device in the manoeuvring station.
